(19) United States
(12) Patent Application Publication
(10) Pub. No.: US 2010/0288813 A1
(43) Pub. Date: Nov. 18, 2010

(54) Tag Tool Protective Device, System, and Method

(76) Inventors: Raymond E. Davis, Heath, TX (US); Clifton Glenn Hampton, Burleson, TX (US)

Correspondence Address: FISH & RICHARDSON P.C., P.O. BOX 1022, MINNEAPOLIS, MN, 55440-1022, US

(21) Appl. No.: 12/467,431

(22) Filed: May 18, 2009

(51) Int. Cl. B65C 7/00

(52) U.S. Cl. 227/67

(57) ABSTRACT

A protective assembly for a tag tool includes a shoe, a shoe spring coupled to the shoe, a tag spring, and a thimble. The shoe includes a shoe bore extending through a distal end of the shoe, where the shoe is adapted to attach to a tag tool having a tag tool needle extending from the tool. The tag spring is coupled to the shoe adjacent the shoe spring and distal ends of the shoe spring and tag spring define an opening to receive a product tag therebetween. The distal end of the tag spring and the shoe define a slot to receive a product material therebetween. The thimble is adapted to move through the shoe bore in response to a force applied to a distal end of the thimble and transmit at least a portion of the force to the tag spring and the shoe spring.

### TECHNICAL FIELD

This disclosure relates to devices and systems for attaching tags to product material, and more particularly, to safety and protective devices, systems, and methods used with tag tools or tagging guns.

### BACKGROUND

Various methods and devices are used for securing product tags to consumer and commercial products. In some instances, such product tags may include tags made of plastic, metal, or other hard materials, and may include one or more electronic devices used as, for example, theft prevention devices. In other instances, product tags may be made of paper, cardboard, or other more pliable material and may be used to provide identifying information regarding the product itself. As one example, product tags for clothing products may generally be paper tags identifying such information as manufacturer, size, price, as well as other information.

Clothing product tags may often be attached to the clothing item (e.g., shirts, pants, socks) by a variety of techniques. For example, certain techniques utilize a device or tool called a tag tool or tagging gun. Tag tools often operate to create a small hole through the product and, in some cases, the product tag, through the use of a hollow needle or other penetrating component. Upon creation of the small hole, the tag tool may be manipulated to insert a fastener (e.g., nylon, plastic) through the hollow needle and then through the holes formed in the product tag and product material. Such fasteners, typically, are flexible filaments with enlarged portions on each end. For instance, the fasteners may be shaped substantially similar to the cross-section of an “I-beam.” Upon insertion of the nylon fastener through such holes, the enlarged ends of the fastener extend, thereby securing the product tag to the product material.

Tag tools or tagging guns may come in a variety of forms. Typically, however, such tag tools may include either a fixed needle or a retractable needle. In fixed needle tag tools, for instance, product material may be manually forced over the needle by the tag tool user. In other words, fixed needle tag tools may include a hollow needle secured in the tag tool and extended from the tag tool at all times. Such fixed needle tag tools, therefore, may create safety concerns with respect to possible injuries to the tag tool user as well as possible damage to the product material. Previous solutions to such safety issues may not fully address this problem. For example, various fixed needle tag tools may include a removable cap or thimble designed to cover the needle during periods of non-use. Such caps or thimbles may be easily lost or misplaced. While some caps or thimbles may be tethered to the tag tool itself by a lanyard or string, such protection relies on the user to replace the cap or thimble on the needle after using the tag tool.

Retractable needle tag tools may generally include a hollow needle that retracts into a housing or handle of the tag tool during periods of non-use. More specifically, a user of a retractable needle tag tool may initiate an action (e.g., pull a trigger or lever) that extends the needle from the tag tool and through the product material and product tag, while simultaneously forcing the product tag through the hollow needle and the resultant holes. Such tag tools, while possibly providing increased safety to user and product material, typically include greater mechanical complexity. Such complexity may decrease the reliability of the tool while increasing cost.

### SUMMARY

In one general embodiment, a protective assembly for a tag tool includes a shoe, a shoe spring coupled to the shoe, a tag spring, and a thimble. The shoe includes a shoe bore extending through a distal end of the shoe, where the shoe is adapted to attach to a tag tool having a tag tool needle extending from the tool. The shoe bore has a centerline substantially aligned with a longitudinal dimension of the tag tool needle. The tag spring is coupled to the shoe adjacent the shoe spring and distal ends of the shoe spring and tag spring define an opening to receive a product tag therebetween. The distal end of the tag spring is adjacent the shoe and the distal end of the tag spring and the shoe define a slot to receive a product material therebetween. The thimble is coupled to the shoe and adapted to move through the shoe bore in response to a force applied to a distal end of the thimble and transmit at least a portion of the force to the tag spring and the shoe spring.

In some specific embodiments, the protective assembly may further include a thimble tip coupled to the distal end of the thimble, where the thimble tip is adapted to receive the force and transmit the force to the thimble. The protective assembly may further include a thimble spring disposed over the thimble, where the thimble spring is adapted to constrict to a compressed state in response to the force applied to the thimble and extend to an uncompressed state in response to release of the force from the thimble. The thimble spring may urge the thimble through the shoe bore away from the tag spring as the thimble spring extends from the compressed state to the uncompressed state. In some aspects, the tag spring and the shoe spring may include corresponding slots substantially aligned therethrough, where the tag spring and the shoe spring may be adapted to be impaled over the tag tool needle through the corresponding slots in response to the portion of the force transmitted to the tag spring and the shoe spring from the thimble.

In particular embodiments, the tag spring and the shoe spring may be adapted to secure the product tag therebetween without support of the product tag by a user. Further, the shoe and the shoe spring may be adapted to secure the product material therebetween without support of the product material by a user.

In another general embodiment, a product tagging system includes a tag tool and a protective assembly. The tag tool includes a housing and a tag tool needle extending from the housing. The protective assembly includes a shoe, a shoe spring coupled to the shoe, a tag spring, and a thimble. The shoe is attached to the tag tool and includes a shoe bore extending through a distal end of the shoe, where the shoe bore has a centerline substantially aligned with a longitudinal dimension of the tag tool needle. The tag spring is coupled to the shoe adjacent the shoe spring and distal ends of the shoe spring and tag spring define an opening to receive a product tag therebetween. The distal end of the tag spring adjacent the shoe and the shoe define a slot to receive a product material therebetween. The thimble is coupled to the shoe and adapted to move through the shoe bore in response to a force applied to a distal end of the thimble and transmit at least a portion of the force to the tag spring and the shoe spring to move the tag spring and the shoe spring over a sharpened end of the tag tool needle.

In specific embodiments, the product tagging system may further include a thimble tip coupled to the distal end of the thimble, where the thimble tip is adapted to receive the force and transmit the force to the thimble. The product tagging system may further include a thimble spring disposed over the thimble, where the thimble spring is adapted to constrict to a compressed state in response to the force applied to the thimble and extend to an uncompressed state in response to the force released from the thimble. The thimble spring may urge the thimble through the shoe bore away from the tag spring as the thimble spring extends from the compressed state to the uncompressed state. Further, the tag spring and the shoe spring may include corresponding slots substantially aligned therethrough, where the tag spring and the shoe spring are impaled on a portion of the tag tool needle through the corresponding slots in response to the portion of the force transmitted to the tag spring and the shoe spring from the thimble.

In particular embodiments, the tag spring and the shoe spring may be adapted to secure the product tag therebetween without support of the product tag by a user. Further, the tag spring and the shoe may be adapted to secure the product material therebetween without support of the product material by a user. In addition, the tag tool needle may be held substantially stationary in the housing as the tag spring and shoe spring move over the sharpened end of the tag tool needle.

In some embodiments, the product tagging system may further include a needle container including a tube adapted to receive at least a portion of the tag tool needle; and a cap substantially enclosing a first end of the tube. The tube may be adapted to enclose at least two tag tool needles. Further, in some embodiments of the product tagging system, at least a portion of the shoe may be integrally formed with a portion of the housing. The shoe and the housing may be integrally formed as a two-piece clam shell.

In another general implementation, a method for using a tag tool includes providing a tag tool system, where the system includes a housing; a tag tool needle extending from the housing; and a protective assembly. The protective assembly includes a shoe attached to the housing and including a shoe bore extending through a distal end of the shoe. The shoe bore has a centerline substantially aligned with a longitudinal dimension of the tag tool needle. The assembly also includes a shoe spring coupled to the shoe and a tag spring coupled to the shoe adjacent the shoe spring, where distal ends of the shoe spring and tag spring define an opening and the distal end of the tag spring and the shoe defining a slot. The assembly also includes a thimble coupled to the shoe and having a centerline substantially aligned with the centerline of the shoe bore. The method includes applying a force to a distal end of the thimble to urge at least a portion of the thimble through the shoe bore, where the thimble transmits at least a portion of the force to the tag spring and the shoe spring to move the tag spring and the shoe spring over a sharpened end of the tag tool needle.

In certain embodiments, the method may further include inserting a product tag in the opening; securing the product tag between the tag spring and the shoe spring without additional support; inserting a product material in the slot; and securing the product material between the tag spring and the shoe without additional support. The tag tool needle may be a used tag tool needle and the method may further include replacing the used tag tool needle with a new tag tool needle without human contact of the used tag tool needle or the new tag tool needle. In some embodiments, the tag tool system may further include a needle container including a tube and a cap, where the tube has open first and second ends and the cap may be adapted to enclose one of the open first and second ends. Replacing the used tag tool needle with a new tag tool needle without human contact of the used tag tool needle or the new tag tool needle may include inserting the open first end of the tube through the shoe bore; inserting the open first end of the tube over the used tag tool needle extended from the housing; releasing at least a portion of the used tag tool needle into the tube through the open first end; and withdrawing the tube including the used tag tool needle through the shoe bore.

In particular embodiments, the needle container may further include the new tag tool needle enclosed within the tube, where the cap encloses the open second end of the tube. Replacing the used tag tool needle with a new tag tool needle without human contact of the used tag tool needle or the new tag tool needle may include removing the cap from the open second end of the tube to expose at least a portion of the new tag tool needle from the open second end; inserting the open second end of the tube through the shoe bore; securing the portion of the new tag tool needle in the housing; and withdrawing the tube through the shoe bore. Further, replacing the used tag tool needle with a new tag tool needle without human contact of the used tag tool needle or the new tag tool needle may include replacing the used tag tool needle with a new tag tool needle without human contact of the used tag tool needle and the new tag tool needle.

Various implementations of a product tagging system according to the present disclosure may include one or more of the following features. For example, the product tagging system may help protect a user of a tag tool from injury from a sharp needle during periods of use, as well as non-use, of the tag tool. The product tagging system may decrease the chances for disease transmission among multiple users of a tag tool. The product tagging system may allow for removal of a used needle of a tag tool without any human contact with the used tag tool needle. Further, the product tagging system may allow for installation of a new needle in a tag tool without any human contact with the new tag tool needle. The product tagging system may allow for containment and transport of used tag tool needles safely without human contact with the needles. The product tagging system may also help protect a product or material from damage, such as unwanted holes, rips, tears, or other injury inflicted by a needle of a tag tool. The product tagging system may also provide for safer shipping of used and new tag tool needles, thereby decreasing injury to transport personnel and carriers.

Various implementations of a product tagging system according to the present disclosure may also include one or more of the following features. For example, the product tagging system may include a separate loading area for a product tag and product material away from an extended needle in a fixed needle tag tool. The product tagging system may allow for tagging of product material while a user maintains a safe distance from a tag tool needle. The product tagging system may allow for faster and more efficient tagging of product material with less concern for possible injury. Further, the product tagging system may help meet regulatory safety requirements imposed on a user or business enterprise. The product tagging tool may also provide for safer and more cost-effective tagging of product material using a fixed needle tag tool as compared to a retractable needle tag tool. Additionally, the product tagging system may allow for single-handed operation of a tag tool, including a fixed needle tag tool.

These general and specific embodiments may be implemented using a device, system, or method, or any combinations of devices, systems, or methods. The details of one or more embodiments are set forth in the accompanying drawings and the description below. Other features will be apparent from the description and drawings, and from the claims.

### DESCRIPTION OF DRAWINGS

FIG. 1 illustrates one embodiment of a product tagging system according to the present disclosure;

FIG. 2 illustrates one embodiment of a tag tool including a protective assembly according to the present disclosure;

FIG. 3A illustrates one embodiment of a protective assembly for a tag tool according to the present disclosure;

FIG. 3B illustrates one embodiment of a tag spring and a shoe spring of a protective assembly for a tag tool according to the present disclosure; and

FIG. 4 illustrates one embodiment of a needle container of a product tagging system according to the present disclosure.

Like reference symbols in the various drawings indicate like elements.

### DETAILED DESCRIPTION

This disclosure relates to devices and systems for attaching tags to product material, and more particularly, to safety and protective devices, systems, and methods used with tag tools or tagging guns. In some embodiments, a protective assembly may be attached to a fixed needle tag tool and may provide safer handling and use of the tag tool. For instance, the protective assembly may provide a shoe including one or more spring members with apertures therethrough longitudinally aligned with a needle of the tag tool. The spring members may receive a force from the tag tool user as applied to a thimble component attached to the shoe, thereby forcing a product tag and product secured within the shoe over the needle. The tag tool user may thus be protected from the needle by separating the needle from the user through implementation of the spring members, the shoe, as well as the attached thimble. Traditional techniques to secure the tag to the product with the tag tool may then be initiated.

Protective methods and systems for managing a tag tool, including replacing used tag tool needles therein, are presently disclosed. In some embodiments, a tubular container for tag tool needles may be inserted through one or more of the thimble, the shoe, and the spring members and enclose a tag tool needle secured to the tag tool. The used needle may thus be removed from the tag tool within the tubular container with little or no direct contact between the user and the used needle. A new tag tool needle may be similarly installed in the tag tool. For instance, the tubular container from which a portion of a new needle is exposed may be inserted through one or more of the thimble, the shoe, and the spring members. The new needle may then be installed and secured within the tag tool and the tubular container removed from the protective assembly.

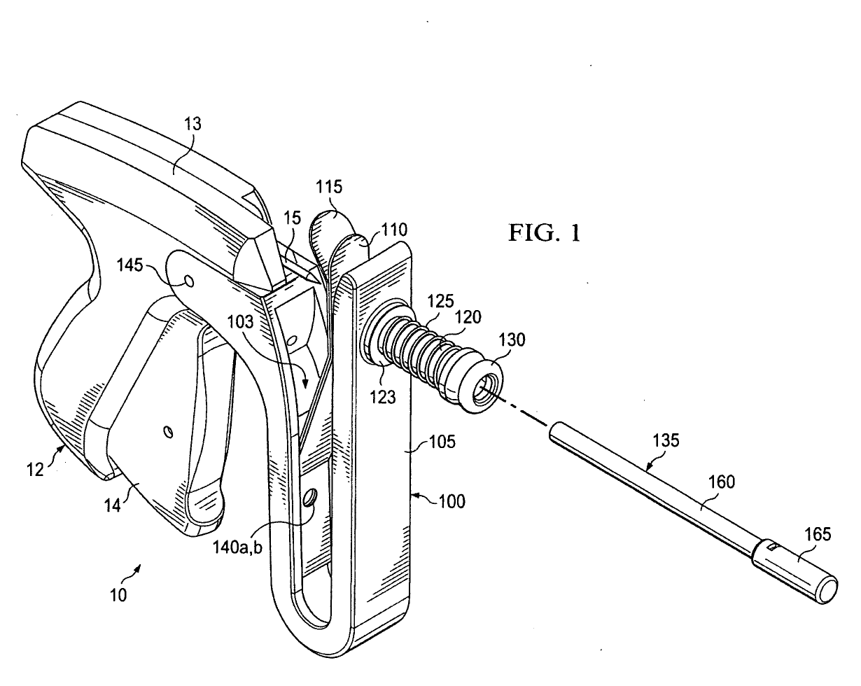

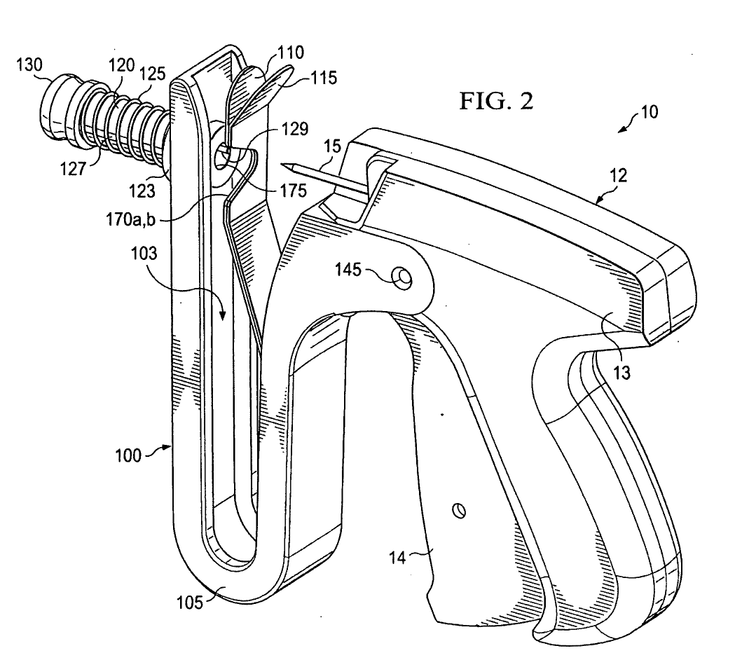

Referring to FIGS. 1-2, one embodiment of a product tagging system 10, including a tag tool 12, a protective assembly 100, and a needle container 135, is illustrated. The product tagging system 10, generally, allows for safer and more efficient tagging of product material as compared to traditional tagging techniques, methods, and devices. Further, the product tagging system 10 may be separable so as to allow various components of the system 10 to be used with existing tagging components. For example, the protective assembly 100 may be implemented as a separate component and used with an existing tag tool, such as a tag tool distinct from that shown in FIGS. 1-2 (tag tool 12). Likewise, the needle container 135 may be used with existing tag tools and protective assemblies such as those distinct or different from the tag tool 12 and protective assembly 100 illustrated in FIGS. 1-2.

Tag tool 12, typically, is a handheld device that includes a handle 13, a trigger 14, and a needle 15. The tag tool 12 may be operated by a user to create one or more holes in a product tag and a product material and then insert a fastener (e.g., a nylon “I-shaped” fastener, not shown) through such holes to secure the product tag to the product material. In some embodiments, the tag tool 12 creates aligned holes through a paper or cardboard product tag and an item of clothing and then inserts the fastener through such holes to secure the tag to the clothing. As illustrated in FIGS. 1-2, the tag tool 12 may be a fixed needle tag tool, such that the needle 15 remains extended from the housing 13 during periods of use and non-use of the tag tool 12. In alternative embodiments, however, the tag tool 12 may be a retracted needle tag tool, such that the user can operate the tag tool 12 to extend the needle 15 from the housing 13 to engage the product tag and/or product material with the needle 15.

In some embodiments, the tag tool 12 may utilize a fine fabric fastener to attach the product tag to the product material. Alternatively, the tag tool 12 may utilize a regular fastener to attach the product tag to the product material. Regardless, reference to the tag tool 12 refers to any tag tool or product tagging device operable to attach a product tag to a product material. Further, as noted above, the tag tool 12 may be a separate component from the product assembly 100 or, alternatively, the tag tool 12 and product assembly 100 may be formed as a single, integral piece.

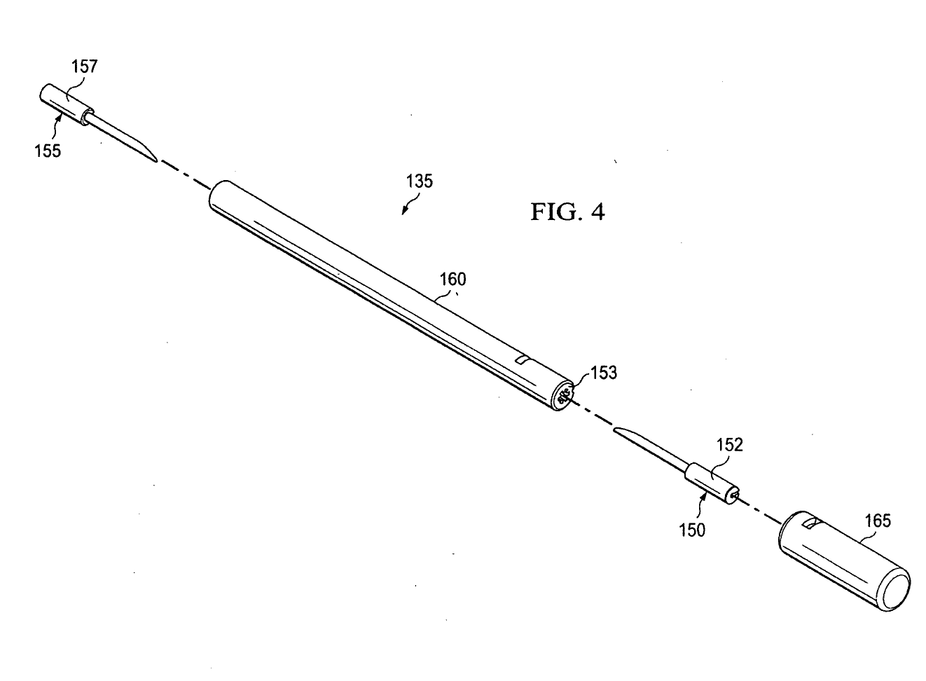

Needle 15, typically, is a tubular metallic component having a void, or hollow portion, extending therethrough. The needle 15 also includes a sharpened point at one distal end designed to penetrate various objects, such as product tags and product material. The needle 15, generally, includes a “C” or crescent cross-sectional area, thus exposing the hollow portion of the needle 15 while maintaining the sharpened point. For example, the needle 15 is typically sharpened so as to penetrate and extend through paper, cardboard, paperboard, cloth, and other similar material. The needle 15 also includes a second distal end opposite the sharpened end, which may be secured to the tag tool 12, thus affixing the needle 15 at a constant position relative to the housing 13. For instance, the needle 15 may include a higher diameter, notched distal end (or base) opposite the sharpened end (as shown more fully in FIG. 4), which may be secured to the tag tool 12 through a locking mechanism engaged to the notched end (base). Alternatively, the needle 15 may be affixed within the housing 13 without the notched distal end by simply providing a snug fit of the needle 15 within the housing 13. Regardless, the needle 15 is typically removable from the tag tool 12 in order to replace the needle 15, such as when it becomes dull, contaminated, or broken.

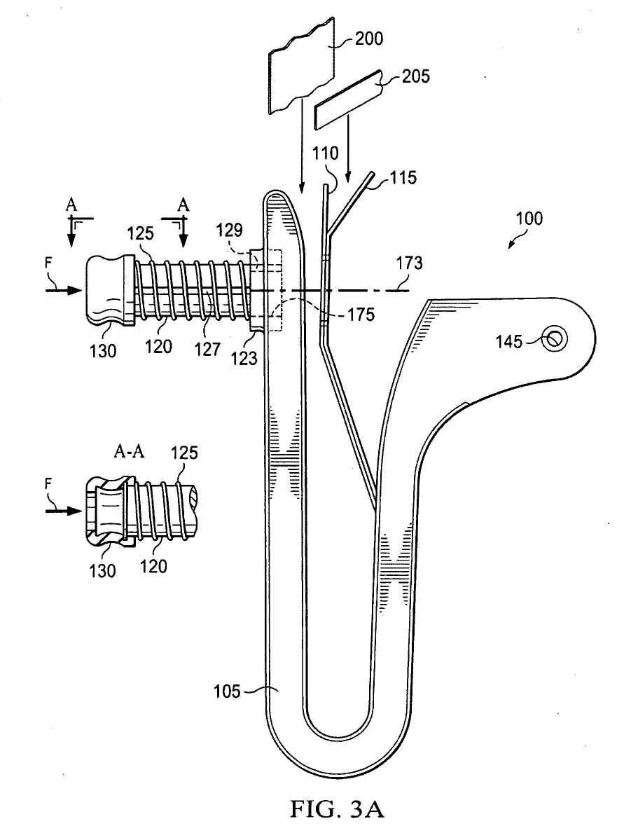

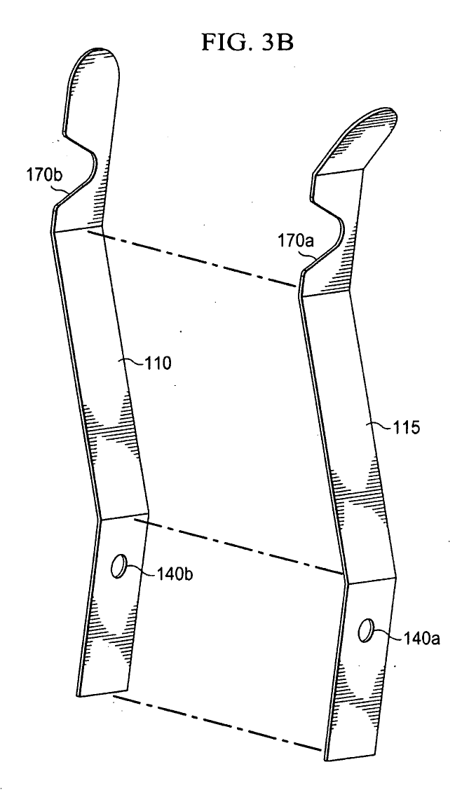

The hollow portion of the needle 15 extends to the sharpened distal end and allows the fastener to be ejected therethrough in order to secure the product tag to the product material. For example, during operation of the product tagging system 10, subsequent to the creation of one or more holes through the product tag and product material (explained more fully below with reference to FIG. 3A), the user may operate the tag tool 12 to eject the fastener through the created holes, thus securing the product tag to the product material with the fastener. For instance, the user may, typically, engage the trigger 14 of the tag tool 12 (e.g., apply force to retract the trigger 14 into the housing 13), which forces a fastener stored in the housing 13 through the hollow portion of the needle 15. Releasing the trigger 14 may then load an additional fastener stored within the housing 13 into a position ready to be ejected through the needle 15.

The needle 15, in some embodiments, may be a fine fabric needle rather than, for example, a regular fabric needle. In some embodiments, the needle 15 may thus have a decreased length and decreased diameter as compared to the regular fabric needle. In any event, reference to the needle 15 refers to any appropriate needle used with a tag tool, such as the tag tool 12, as well as any other product tagging device or system.

Protective assembly 100, typically, is secured to the tag tool 12 at one or more locations, such as at connection points 145 on either side of the housing 13. For example, the protective assembly 100 may be secured to the housing 13 at points 145 by screws, rivets, or other mechanical fastening techniques, as well as adhesives or compression fittings (e.g., detents). Generally, however, the protective assembly 100 is detachable from the tag tool 12 and thus may be used with multiple tag tools 12 or alternative tag tools.

The protective assembly 100 includes a shoe 105, a tag spring 110, a shoe spring 115, and a thimble 120. In some embodiments, the protective assembly 100 may also include a thimble tip 130 and a thimble spring 125. During typical operation (explained more fully with reference to FIG. 3A), the protective assembly 100 allows the user to apply force to the thimble 120 so as to force a product tag and product material over the needle 15, thereby impaling the product tag and the product material on the needle 15. In doing so, the protective assembly 100 may allow the user and the product material to avoid unwanted and harmful contact with the needle 15.

The shoe 105, typically, is made of plastic, aluminum, or other rigid material and extends from the tag tool 12 from the connection points 145 on either side of the housing 13. As illustrated, the shoe 105 is substantially U-shaped and extends downward from the tag tool 12, thus creating an area to receive product material. The shoe 105, further, extends upward in front of the needle 15 and includes a shoe bore 175 therethrough. The shoe bore 175, typically, is aligned with the needle 15 such that a centerline 173 (shown in FIG. 3A) traversing through the shoe bore 175 is aligned with the needle 15.

In some embodiments, the shoe 105 and the housing 13 are integrally formed as a single or multi-piece structure. For example, the shoe 105 and the housing 13 may be integrally formed as a two-piece, or clam shell, structure such that the two halves of the structure are secured together to form the shoe 105 and housing 13 as a single component of the product tagging system 10. The shoe 105 and housing 13 may be secured by any appropriate technique, including mechanical (e.g., rivets, screws, or pin and socket), as well as adhesives.

In some embodiments, the shoe 105 includes a recessed channel 103 (shown in FIG. 2) extending around all or a portion of an interior surface of the shoe 100. The recessed channel 103 may provide for a seating area in which one or both of the tag spring 110 and the shoe spring 115 may be inserted and secured to the shoe 105. Further, the recessed channel 103 may provide for a lighter and less costly shoe 100, thereby increasing the ease of connection of the shoe 100 to the housing 13, for example.

The shoe spring 115 is secured to the shoe 100 through a spring bore 140a (e.g., by rivet or screw) and, generally, is a leaf-type spring made of a flexible but rigid material such as, for example, steel, aluminum, plastic, or other appropriate material. The shoe spring 115 establishes a neutral loading area in front of the needle 15 that separates the product tag and product material from the needle 15. This area may be adjusted according to the shoe spring 115. For instance, the shoe spring 115 may include multiple (e.g., three) angled segments in which at least one segment is angled away from the needle 15 to create the loading area. By adjusting the angles between the segments of the shoe spring 115, this area may be increased or decreased.

The shoe spring 115 typically includes a notch 170a formed therein, as illustrated in FIGS. 2 and 3B. The notch 170a, while illustrated as a cut-out or crescent-shaped aperture through the shoe spring 115, may be any appropriately shaped aperture that allows the needle 15 to pass through the shoe spring 115 during operation of the product tagging system 10. For example, the notch 170a may be a circular aperture through the shoe spring 115 with a center of the circle substantially aligned with the needle 15. The notch 170a, however, may typically extend to an exterior edge of the shoe spring 115.

The tag spring 110 is secured to the shoe 100 through a spring bore 140b (e.g., by rivet or screw) and, generally, is a leaf-type spring made of a flexible but rigid material such as, for example, steel, aluminum, plastic, or other appropriate material. As illustrated, the tag spring 110 is secured to the shoe 100 immediately adjacent the shoe spring 115 such that the shoe spring 115 is between the tag spring 110 and the needle 115. In some embodiments, the tag spring 110 and shoe spring 115 are in physical contact through at least a portion of the lengths of the springs 110 and 115. Further, the tag spring 110 may apply a spring force against the shoe spring 115, thereby maintaining physical contact between the springs 110 and 115. Alternatively, the tag spring 110 and shoe spring 115 may not contact each other but may have a relatively small clearance therebetween, thereby allowing a product tag to be secured and held steady between the springs 110 and 115.

The tag spring 115 typically includes a notch 170b formed therein, as illustrated in FIGS. 2 and 3B, similar to or substantially the same as the notch 170a in the shoe spring 115. The notches 170a and 170b, however, may be distinct as long as each allows the needle 15 to penetrate through their respective springs 110 and 115 and a fastener to be removed therethrough. The notches 170a and 170b may also, in some embodiments, serve as a target guide to locate an exact penetration location of the product tag by the needle 15 and also an exact penetration location of the fastener through the product tag and product material.

Turning to FIG. 3B, this figure illustrates in more detail one embodiment of the tag spring 110 and the shoe spring 115 of the protective assembly 100. As illustrated, the springs 110 and 115 may be substantially similar in shape and design, including multiple segments therein. When coupled to the shoe 100, such segments may be substantially aligned (as shown according to the connecting dashed lines), thereby allowing the springs 110 and 115 to be in close proximity or in contact. In some embodiments, as illustrated in FIGS. 1-2 and 3A-B, the shoe spring 115 may include a top segment angled so as to create a concave or V-shaped area to receive the product tag therein. Alternatively, the shoe spring 115 and tag spring 110 may remain in close proximity or physical contact throughout the lengths of the springs 110 and 115.

The combination of the springs 110 and 115, in some embodiments, may combine to form a product tag holder. For example, the product tag holder may serve as a guard for the user of the tag tool 12 to prevent contact with the point of the needle 15. The product tag holder may also serve as a separator from the product material to which the product tag is being attached. The product tag holder may also create a clearance for the product material such that the user may more easily locate a desired penetration point for the fastener through the product tag and the product material. In some embodiments, the product tag holder may also assist in the removal of the product material from the needle 15, allowing the user to disconnect the fastener and tag. For instance, by pushing the product material off the needle 15, the product tag holder may create a clearance for removal of the product material as it is removed from the shoe 105. In other words, the product tag holder may act as a “spring” to help push the product material off of the needle 15 while protecting the user.

Returning to FIGS. 1-2, the thimble 120, as illustrated, is a substantially cylindrical and elongated tube coupled to the shoe 100. In some embodiments, as illustrated in these figures, the thimble 120 may be coupled to the shoe 100 through a grommet 123. Generally, as described more fully with reference to FIG. 3A, the thimble 120 may receive a force (e.g., applied by the user or applied by another object or surface) and extend through the shoe bore 175 to transmit the force to the springs 110 and 115. More specifically, the thimble 120 may provide a safe (i.e., non-sharpened or rounded) location on which the user may manually apply the force in order to impale the needle 15 through the thimble 120 and the springs 110 and 115, as well as the product tag and product material inserted therein. Thus, the user may be kept a safe distance from the sharpened end of the needle 15.

In some embodiments, the thimble 120 may include an indexing notch 127 disposed lengthwise along at least a portion of an outer surface of the thimble 120. In such embodiments, the shoe bore 175 may include an indexing rib 129 disposed on an outer surface of the shoe 105 through the shoe bore 175. When a force is applied to the thimble 120 to urge the thimble 120 through the shoe bore 175, the indexing rib 129 may generally mate with the indexing notch 127 to allow the thimble 120 to slide through the bore 175. Misalignment of the indexing notch 127 with the indexing rib 129 may thus prevent or substantially prevent the thimble 120 from sliding through the shoe bore 175 and thus transferring the force to the springs 110 and 115. Thus, in some embodiments of the protective assembly 100, the thimble 120 is aligned with the shoe bore 175 such that the indexing notch 127 and indexing rib 129 are in substantially constant alignment, allowing the thimble 120 to travel through the shoe bore 175.

In some alternative embodiments, such a mating between the thimble 120 and the shoe 105 to effectuate this transfer of force may be used as a locking technique for the product tagging system 10. For example, use of the protective assembly 100 and tag tool 12 may be restricted, thereby preventing one or more holes to be created in the product tag and product material by the needle 15, when the indexing rib 129 and indexing notch 127 are misaligned.

In other alternative embodiments, this locking technique may be accomplished in a different fashion. For example, the shoe bore 175 and thimble 120 may each have a substantially square, triangular, pentagonal, or octagonal cross-section (to name but a few), thus requiring alignment of the cross-sections between the shoe bore 175 and thimble 120 in order for the thimble 120 to be urged through the shoe bore 175. In other embodiments, however, the locking technique may not be included and the thimble 120 may be urged through the shoe bore 175 without substantially any indexing.

The protective assembly 100, as illustrated, may also include a thimble tip 130 coupled to thimble 120 at a distal end of the thimble 120 opposite the shoe 105. The thimble tip 130, generally, may provide a location for the user to apply a force to the thimble 120 substantially directed along the centerline 173 of the thimble 120. Further, the thimble tip 130 may be a rubber or plastic bumper that is snap-fit on the distal end of the thimble 120 and elastic so as to provide a protective surface to the user or any other object utilized to apply the force to the thimble 120. In some embodiments, as illustrated by section ‘A-A’ in FIG. 3A, the thimble tip 130 fits on and provides a skirt over the thimble spring 125.

The thimble spring 125, typically, is a metal or plastic wire compression spring disposed over the thimble 120 and in compression to urge the thimble 120 away from the springs 110 and 115 and the needle 15 and through the shoe bore 175 to its rest position. In some embodiments, the thimble spring 125 may continuously apply a spring force to the thimble 120 away from the needle 15. In other embodiments, however, the thimble spring 125 may come to a neutral state while the thimble 120 is in the rest position and thereby apply substantially no force to the thimble 120. In some embodiments, the thimble spring 125 is plumb at each of its ends and applies the spring force to the thimble tip 130, which is then transmitted to the thimble 120. Alternatively, the thimble spring 125 may be directly coupled to the thimble 120 thereby directly applying the spring force to the thimble 120.

Referring now to FIGS. 1 and 4, the needle container 135 is illustrated. The needle container 135 includes a tube 160, one or more caps 165, and in some embodiments, a new needle 150. The needle container 135, typically, allows a user to remove a used tag tool needle, such as used needle 155 or the needle 15, from a tag tool, such as tag tool 12, without any contact with the used needle 155. Further, the needle container 135 allows the user to install the new needle 150 into the housing 13 of the tag tool 12 without any contact with the new needle 150. In such fashion, the needle container 135 may substantially reduce the risk of disease transmission through human contact with a contaminated tag tool needle, as well as reduce the risk of injury to the user from a new tag tool needle.

The tube 160 typically is an elongated and hollow container sized to accept a tag tool needle therein via one or both open ends of the tube 160. In some embodiments, the tube 160 may serve as a shipping and handling container, and be used in multiple instances to transport the new needle 150 and/or the used needle 155. In alternative embodiments, the tube 160 may be a disposable container that allows for safe disposal of the used needle 155. As illustrated, the tube 160 may be translucent and include an indexing notch 153 disposed longitudinally along at least a portion of an outer surface of the tube 160. The indexing notch 153, in some embodiments, may mate with the indexing rib 129 of the shoe 105 during removal of the used needle 155 and installation of the new needle 150, as described more fully below. Alternatively, the tube 160 may include a substantially smooth outer surface. Although a cylindrical shape is illustrated in FIGS. 1 and 4 for the tube 160, alternative shapes are contemplated by the present disclosure.

The tube 160 receives one or more used tag tool needles 155 and one or more new tag tool needles 150 therein. In some embodiments, the tube 160 may also include an indexing feature to secure one or more of the used and/or new tag tool needles 155 and 150 therein. For instance, in some embodiments, the tube 160 may include an internal indexing rib or guide (not shown) to mate with the “C” or crescent-shaped distal end of the used and new tag tool needles 155 and 150, as well as the needle 15. Thus, alignment of the needles to insert into the tube 160, such as during removal of the used needle 155 and installation of the new needle 150, may be made easier and more reliable. In alternative embodiments, however, the tube 160 may be sized to snugly accept the used needle 155 and the new needle 150 and substantially secure the needles within the tube 160 without an indexing feature.

In some embodiments, one or both of the used needle 155 and new needle 150 may include a base portion. For example, as illustrated in FIG. 4, the new needle 150 may include a base portion 152 while the used needle 155 may include a base portion 157. The base portions 152 and 157 may be permanently or semi-permanently attached to the sharpened portions of the corresponding needles and provide an increased diameter segment. In some embodiments, the base portions 152 and 157 extend to the exterior of the tube 160 when the needles 150 and 155, respectively, are inserted into the tube 160.

The needle container 135 also includes one or more caps 165. The cap 165, generally, may be fit over either of the open ends of the tube 160, thereby substantially preventing accidental or unwanted removal of the used needle 155 and/or new tag tool needle 150 from the tube 160. In some embodiments, the needle container 135 includes a single cap 165, which initially encloses the tube 160 such that the new needle 150 remains therein. Once the used needle 155 is recovered from the tag tool 12, the cap 165 may be removed from the tube 160, thereby uncovering the new needle 150, and replaced onto the tube 160 to enclose the used needle 155 therein. In some embodiments, the cap 165 may be removable from one of the open ends of the tube 160 where the new needle 150 is stored but permanently attached to the tube 160 once engaged with the tube 160 over the other open end where the used needle 155 is stored.

Continuing with FIGS. 1 and 4, one example of a hands-free operation to replace the used needle 155 with the new needle 150 is now described. This example operation may allow a tag tool user to replace the used needle 155 with a new needle 150 without any direct contact with either the used needle 155 or new needle 150, thereby substantially decreasing the risk of injury. Utilizing the tube 160 with an uncapped open end directed towards the thimble tip 130 and a capped closed end enclosing the new needle 150, the user inserts the tube 160 through the thimble tip 130 and the thimble 120, which have substantially aligned bores therethrough. Thus, the thimble 120 and the thimble tip 130 may serve as guides for the tube 160 to be aligned therethrough and, eventually, over the used needle 155.

The tube 160 is then inserted through the shoe bore 175 and corresponding notches 170a and 170b of the shoe spring 115 and tag spring 110, respectively. In some embodiments, prior to insertion of the tube 160 into the shoe bore 175, the tube 160 may be indexed (e.g., rotated) to allow the indexing notch 153 (shown in FIG. 4) to align with the indexing rib 129. The tube 160 is then inserted over the used needle 155 (such as needle 15). If the tube 160 includes an indexing feature, such as the indexing feature described above, the user manipulates (e.g., rotates) the tube 160 to properly index the used needle 155 into the tube 160. Alternatively, if the tube 160 does not include an indexing feature, the tube 160 is slid over the used needle 155 and enclosed therein. The used needle 155, if appropriate, is then released from the tag tool 12 by the user. For example, in some embodiments, the tag tool 12 includes a locking mechanism, which secures the base 157 of the used needle 155 into the housing 13.

Once the used needle 155 is secured within the tube 160, the user withdraws the tube 160 backwards through the notches 170a and 170b, the shoe bore 175, the thimble 120, and the thimble tip 130. The user may then remove the cap 165 from the end of the tube 160 enclosing the new needle 150 and replace the cap 165 onto the tube 160 to enclose the used needle 155. Next, the user rotates the tube 160 and reinserts the tube 160 through the thimble tip 130, thimble 120, shoe bore 175, and notches 170a and 170b. The user then aligns the new needle 150 such that the housing 13 receives the base portion 152 therein. Once inserted, the new needle 150 may be locked into the housing 13 and the tube 160 withdrawn from the protective assembly 100.

Turning now to FIG. 3A, one example operation and use of the protective assembly 100 of the tag tool 12 is now described. In no particular order, the user inserts a product tag 205 into the loading angle defined by the shoe spring 115 and the tag spring 110 and a product material 200 into the loading space defined by the tag spring 110 and the shoe 105 adjacent the shoe bore 175. The user may position the product tag 205 between the tag spring 110 and shoe spring 115 substantially aligned with the centerline 173 of the shoe bore 175 and the thimble 120. Due to the close proximity of the tag spring 110 and the shoe spring 115, as well as, in some embodiments, the spring force applied by the tag spring 110 to the shoe spring 115, the product tag 205 may be secured therebetween without further support by the user. Further, due to the close proximity of the tag spring 110 and the shoe 105 adjacent the shoe bore 175, the product material 200 may be substantially secured therebetween without further support by the user.

When the product tag 205 and the product material 200 are properly placed within the protective assembly 100, the user may apply a force F to the thimble 120 via the thimble tip 130. In some embodiments, the user may manually apply the force F (e.g., by pressing with one or both hands). Alternatively, the user may employ a separate object or surface to apply the force F to the thimble 120. In any event, at least one or both of the thimble tip 130 and the thimble 120 may allow for a greater force F to be applied by the user to impale the product material 200 and the product tag 205 over the needle 15. Thus, in some embodiments, product tag attachment may be achieved for thicker product material and/or product tags as compared to product tag attachment techniques lacking the protective assembly 100.

In some embodiments, prior to applying the force F, the user may index the thimble 120 with the shoe bore 175 by, for example, rotating the thimble 120 such that the indexing notch 127 may be aligned with the indexing rib 129.

As the force F is applied in sufficient magnitude, the thimble 120 is urged from its rest position through the shoe bore 175 and contacts the product material 200. The thimble 120 continues to press the product material 200 against the tag spring 110 and transfer at least a portion of the force F to the tag spring 110 through the material 200. The force F is thus transferred (in part or in whole) to the shoe spring 115 through the product tag 205, causing the product material 200, the tag spring 110, the product tag 205, and the shoe spring 115 to be urged in the same direction as the force F (left-to-right as illustrated in this example). The product tag 205 and product material 200 are thus impaled against the needle 15 (shown in FIGS. 1-2), creating a hole therethrough, as the needle 15 traverses through the notches 170a and 170b of the shoe spring 115 and tag spring 110, respectively, as well as the thimble 120.

Once holes are created in the product tag 205 and the product material 200 by the needle 15, the tag tool 12 may be operated to insert the nylon fastener through the holes, thereby securing the product tag 205 to the product material 200. The force F may be removed from the thimble 120, thereby allowing the thimble 120, tag spring 110, and shoe spring 115 to return to their respective rest positions. Such return may allow the needle 15 to disengage from the product material 200 and the product tag 205, leaving the nylon fastener securing the material 200 and tag 205 together. The tagged product material 200 may then be removed from the protective assembly 100 such that the fastener is removed through the open notches 170a and 170b of the springs 115 and 110.

In such fashion, the user may more efficiently and more safely secure the product tag 205 to the product material 200. For instance, during this example operation, the user may keep a relatively safe distance away from the needle 15. Further, the user may be able to perform this example operation single-handedly or substantially single-handedly. Those skilled in the art will appreciate other advantages of this example operation and will appreciate that the steps described in this example operation may be performed in sequences different to that described herein. In addition, those of skill in the art will appreciate that additional steps or less steps may be performed in this example operation or other example operations without departing from the scope of the present disclosure.

A number of implementations have been described, and several others have been mentioned or suggested. Furthermore, those skilled in the art will readily recognize that a variety of additions, deletions, alterations, and substitutions may be made to these implementations without departing from the scope of the present disclosure. Thus, the scope of protected subject matter should be judged based on the following claims, which may capture one or more aspects of one or more implementations.

What is claimed is:

1. A protective assembly for a tag tool comprising:
a shoe comprising a shoe bore extending through a distal end of the shoe, the shoe adapted to attach to a tag tool having a tag tool needle extending from the tool, the shoe bore having a centerline substantially aligned with a longitudinal dimension of the tag tool needle;
a shoe spring coupled to the shoe;
a tag spring coupled to the shoe adjacent the shoe spring, wherein distal ends of the shoe spring and tag spring define an opening to receive a product tag therebetween, the distal end of the tag spring adjacent the shoe, the distal end of the tag spring and the shoe defining a slot to receive a product material therebetween; and
a thimble coupled to the shoe and adapted to move through the shoe bore in response to a force applied to a distal end of the thimble and transmit at least a portion of the force to the tag spring and the shoe spring.

2. The protective assembly of claim 1, further comprising a thimble tip coupled to the distal end of the thimble, the thimble tip adapted to receive the force and transmit the force to the thimble.

3. The protective assembly of claim 1, further comprising a thimble spring disposed over the thimble, the thimble spring adapted to constrict to a compressed state in response to the force applied to the thimble and extend to an uncompressed state in response to release of the force from the thimble, the thimble spring urging the thimble through the shoe bore away from the tag spring as the thimble spring extends from the compressed state to the uncompressed state.

4. The protective assembly of claim 1, the tag spring and the shoe spring comprising corresponding slots substantially aligned therethrough, the tag spring and the shoe spring adapted to be impaled over the tag tool needle through the corresponding slots in response to the portion of the force transmitted to the tag spring and the shoe spring from the thimble.

5. The protective assembly of claim 1, wherein the tag spring and the shoe spring are adapted to secure the product tag therebetween without support of the product tag by a user.

6. The protective assembly of claim 1, wherein the shoe and the shoe spring are adapted to secure the product material therebetween without support of the product material by a user.

7. A product tagging system comprising
a tag tool comprising a housing and a tag tool needle extending from the housing; and
a protective assembly comprising:
a shoe attached to the tag tool and comprising a shoe bore extending through a distal end of the shoe, the shoe bore having a centerline substantially aligned with a longitudinal dimension of the tag tool needle;
a shoe spring coupled to the shoe;
a tag spring coupled to the shoe adjacent the shoe spring, wherein distal ends of the shoe spring and tag spring define an opening to receive a product tag therebetween, the distal end of the tag spring adjacent the shoe, the distal end of the tag spring and the shoe defining a slot to receive a product material therebetween; and
a thimble coupled to the shoe and adapted to move through the shoe bore in response to a force applied to a distal end of the thimble and transmit at least a portion of the force to the tag spring and the shoe spring to move the tag spring and the shoe spring over a sharpened end of the tag tool needle.

8. The product tagging system of claim 7, further comprising a thimble tip coupled to the distal end of the thimble, the thimble tip adapted to receive the force and transmit the force to the thimble.

9. The product tagging system of claim 7, further comprising a thimble spring disposed over the thimble, the thimble spring adapted to constrict to a compressed state in response to the force applied to the thimble and extend to an uncompressed state in response to the force released from the thimble, the thimble spring urging the thimble through the shoe bore away from the tag spring as the thimble spring extends from the compressed state to the uncompressed state.

10. The product tagging system of claim 7, the tag spring and the shoe spring comprising corresponding slots substantially aligned therethrough, wherein the tag spring and the shoe spring are impaled on a portion of the tag tool needle through the corresponding slots in response to the portion of the force transmitted to the tag spring and the shoe spring from the thimble.

11. The product tagging system of claim 7, wherein the tag spring and the shoe spring are adapted to secure the product tag therebetween without support of the product tag by a user.

12. The product tagging system of claim 7, wherein the tag spring and the shoe are adapted to secure the product material therebetween without support of the product material by a user.

13. The product tagging system of claim 7, wherein the tag tool needle is held substantially stationary in the housing as the tag spring and shoe spring move over the sharpened end of the tag tool needle.

14. The product tagging system of claim 7 further comprising a needle container, the needle container comprising:
a tube adapted to receive at least a portion of the tag tool needle; and
a cap substantially enclosing a first end of the tube.

15. The product tagging system of claim 14, wherein the tube is adapted to enclose at least two tag tool needles.

16. The product tagging system of claim 7, wherein at least a portion of the shoe is integrally formed with a portion of the housing.

17. The product tagging system of claim 16, wherein the shoe and the housing are integrally formed as a two-piece clam shell.

18. A method for using a tag tool comprising:
providing a tag tool system comprising:
a housing;
a tag tool needle extending from the housing; and
a protective assembly comprising:
a shoe attached to the housing and comprising a shoe bore extending through a distal end of the shoe, the shoe bore having a centerline substantially aligned with a longitudinal dimension of the tag tool needle;
a shoe spring coupled to the shoe;
a tag spring coupled to the shoe adjacent the shoe spring, wherein distal ends of the shoe spring and tag spring define an opening, the distal end of the tag spring adjacent the shoe, the distal end of the tag spring and the shoe defining a slot; and
a thimble coupled to the shoe and having a centerline substantially aligned with the centerline of the shoe bore; and
applying a force to a distal end of the thimble to urge at least a portion of the thimble through the shoe bore, wherein the thimble transmits at least a portion of the force to the tag spring and the shoe spring to move the tag spring and the shoe spring over a sharpened end of the tag tool needle.

19. The method of claim 18 further comprising:
inserting a product tag in the opening;
securing the product tag between the tag spring and the shoe spring without additional support;
inserting a product material in the slot; and
securing the product material between the tag spring and the shoe without additional support.

20. The method of claim 18, the tag tool needle comprising a used tag tool needle, the method further comprising replacing the used tag tool needle with a new tag tool needle without human contact of the used tag tool needle or the new tag tool needle.

21. The method of claim 20, the tag tool system further comprising a needle container including a tube and a cap, the tube having open first and second ends, the cap adapted to enclose one of the open first and second ends, wherein replacing the used tag tool needle with a new tag tool needle without human contact of the used tag tool needle or the new tag tool needle comprises:
inserting the open first end of the tube through the shoe bore;
inserting the open first end of the tube over the used tag tool needle extended from the housing;
releasing at least a portion of the used tag tool needle into the tube through the open first end; and
withdrawing the tube including the used tag tool needle through the shoe bore.

22. The method of claim 21, the needle container further comprising the new tag tool needle enclosed within the tube, the cap enclosing the open second end of the tube, wherein replacing the used tag tool needle with a new tag tool needle without human contact of the used tag tool needle or the new tag tool needle comprises:
removing the cap from the open second end of the tube to expose at least a portion of the new tag tool needle from the open second end;
inserting the open second end of the tube through the shoe bore;
securing the portion of the new tag tool needle in the housing; and
withdrawing the tube through the shoe bore.

23. The method of claim 20, wherein replacing the used tag tool needle with a new tag tool needle without human contact of the used tag tool needle or the new tag tool needle comprises replacing the used tag tool needle with a new tag tool needle without human contact of the used tag tool needle and the new tag tool needle.
